(19) United States
(12) Patent Application Publication
(10) Pub. No.: US 2015/0099404 A1
(43) Pub. Date: Apr. 9, 2015

(54) CONNECTOR

(71) Applicant: Molex Incorporated, Lisle, IL (US)

(72) Inventor: Takashi Iida, Yamato (JP)

(73) Assignee: Molex Incorporated, Lisle, IL (US)

(21) Appl. No.: 14/503,613

(22) Filed: Oct. 1, 2014

(30) Foreign Application Priority Data
Oct. 4, 2013 (JP) 2013-209050

(51) Int. Cl. H01R 13/436; H01R 13/506

(52) U.S. Cl. CPC H01R 13/4361; H01R 13/506
USPC 439/752

(57) ABSTRACT

A connector comprises a cover 4 having a panel portion 41 which covers a portion of the opening of a retaining hole 3a formed in an outer peripheral surface 31 of a case body 3, a retainer 5 having a recessed portion 5a corresponding to the panel portion 41, and the panel portion 41 having an opposing surface 412 opposing the bottom surface 521 of the recessed portion 5a.

### RELATED APPLICATION

This application claims priority to Japanese Application No. 2013-209050, filed Oct. 4, 2013, which is incorporated herein by reference in its entirety.

### TECHNICAL FIELD

The current disclosure relates to a connector and, more specifically, to the shape and structure of the enclosure of the connector.

### BACKGROUND ART

In the connector disclosed in Patent Document 1, the terminals inside the case body are engaged by a retainer inserted into a side surface of the case body.

[Patent Document 1]Laid-Open Patent Publication No. 2001-76800

### SUMMARY OF THE INVENTION

However, the retainer sometimes becomes detached from the case body of the connector.

It is an object of the connector to solve this problem by providing a connector capable of keeping the retainer from becoming detached.

In order to solve this problem, the connector comprises: a case body including a plurality of terminal holes passing through the case body in one direction and receiving terminals inserted from one side, an opening formed in a side surface relative to the one direction, and a retaining hole extending from the opening in a direction orthogonal to the one direction and communicating with the plurality of terminal holes; a retainer inserted into the retaining hole and engaging the terminals inserted into the terminal holes; and a cover attached to the other side of the case body in the one direction and including a plurality of terminal holes corresponding to the terminal holes; the cover having a panel portion covering a portion of the opening, the retainer having a recessed portion corresponding to the panel portion, and the panel portion having an opposing surface opposing the bottom surface of the recessed portion.

In one aspect of the connector, the panel portion further comprises a contact surface contacting a side surface of the case body, the opposing surface and the contact surface being on the same plane.

In another aspect of the connector, the position of the bottom surface of the recessed portion is closer to the opening than the terminal holes in the insertion direction of the retainer when the retainer has been inserted into the retaining hole and has engaged the terminals inserted into the terminal holes.

In another aspect of the connector, the panel portion does not include a cutout portion.

In another aspect of the connector, the side surface of the case body opposite the side surface having the opening is formed in a planar shape.

When the retainer moves in the direction of detachment, the opposing surface of the panel portion of the cover comes into contact with the bottom surface of the recessed portion in the retainer, thereby keeping the retainer from becoming detached.

### BRIEF DESCRIPTION OF THE DRAWINGS

FIG. 1 is a perspective view of the connector in an embodiment of the connector;

FIG. 2 is an exploded perspective view of the same connector;

FIG. 3 is a perspective view of the case for the same connector;

FIG. 4 is a cross-sectional view from line IV-IV in FIG. 3; and

FIG. 5 is a cross-sectional view from line IV-IV in FIG. 3.

### DETAILED DESCRIPTION OF THE PREFERRED EMBODIMENTS

The following is an explanation of an embodiment of the with reference to the drawings.

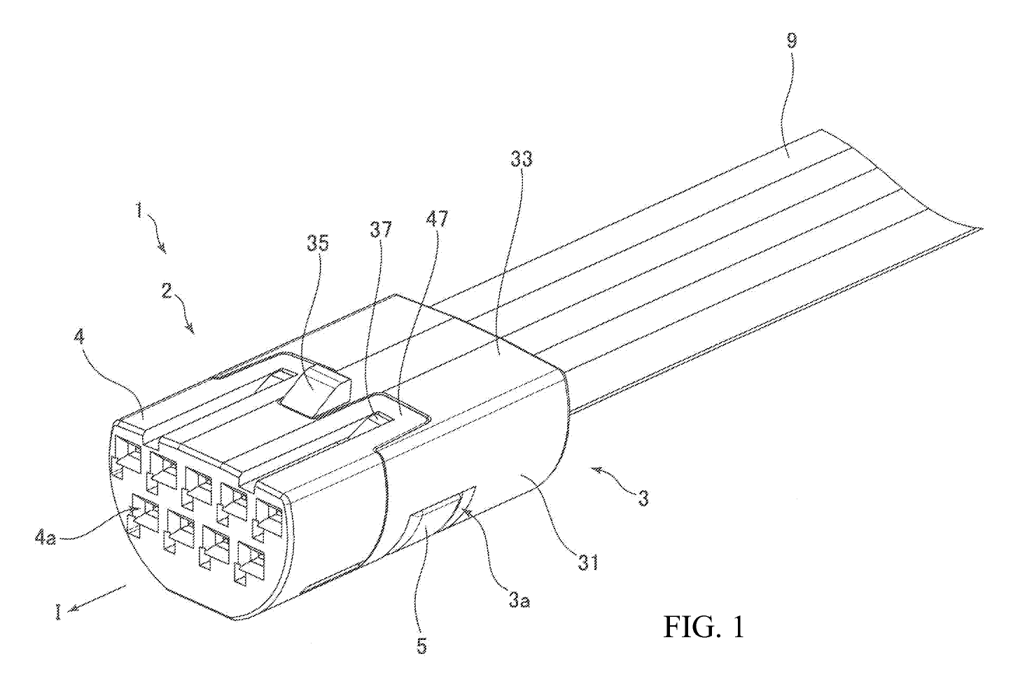

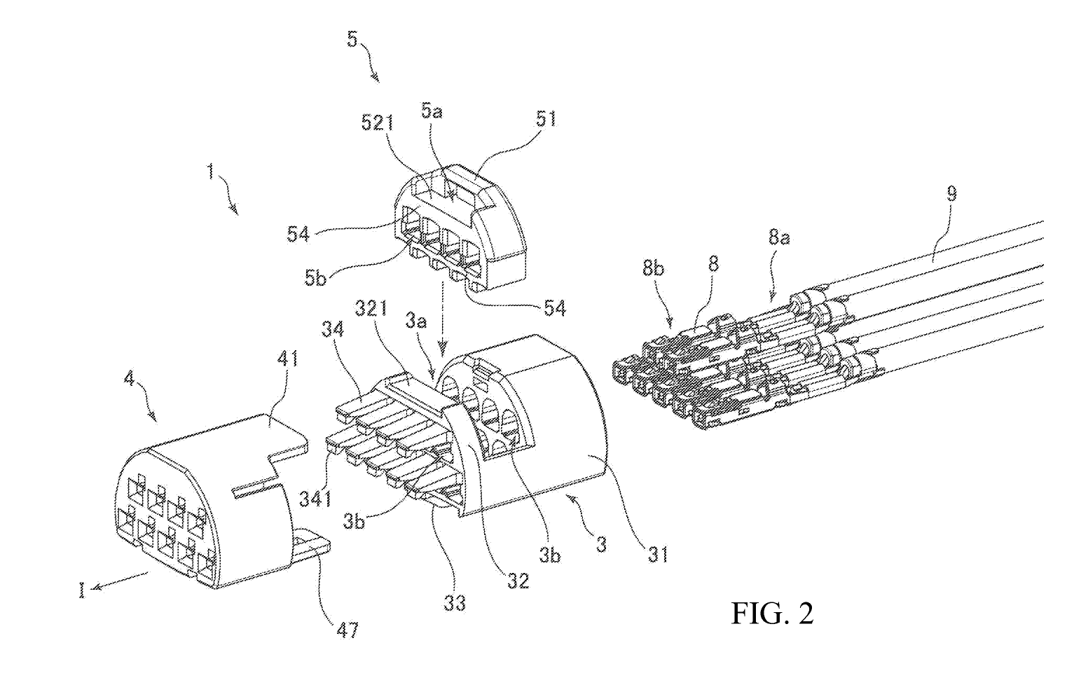

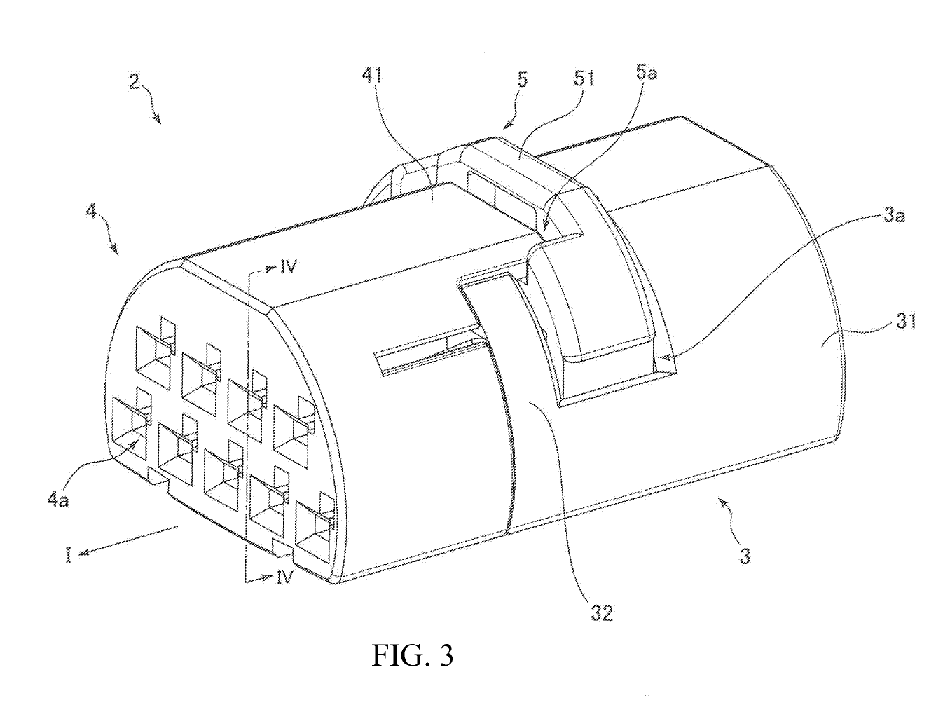

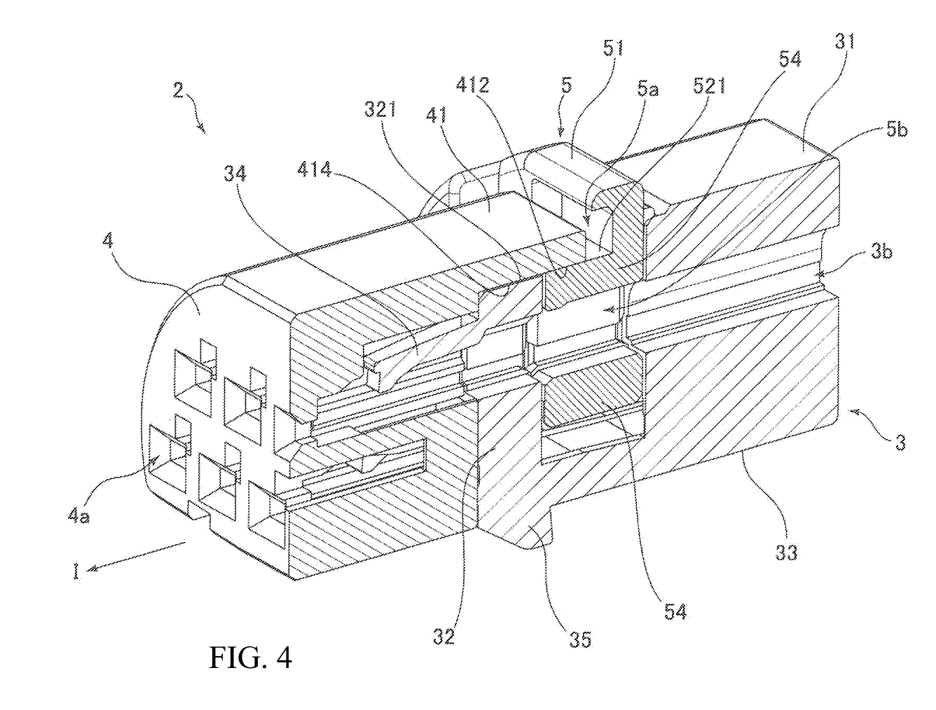

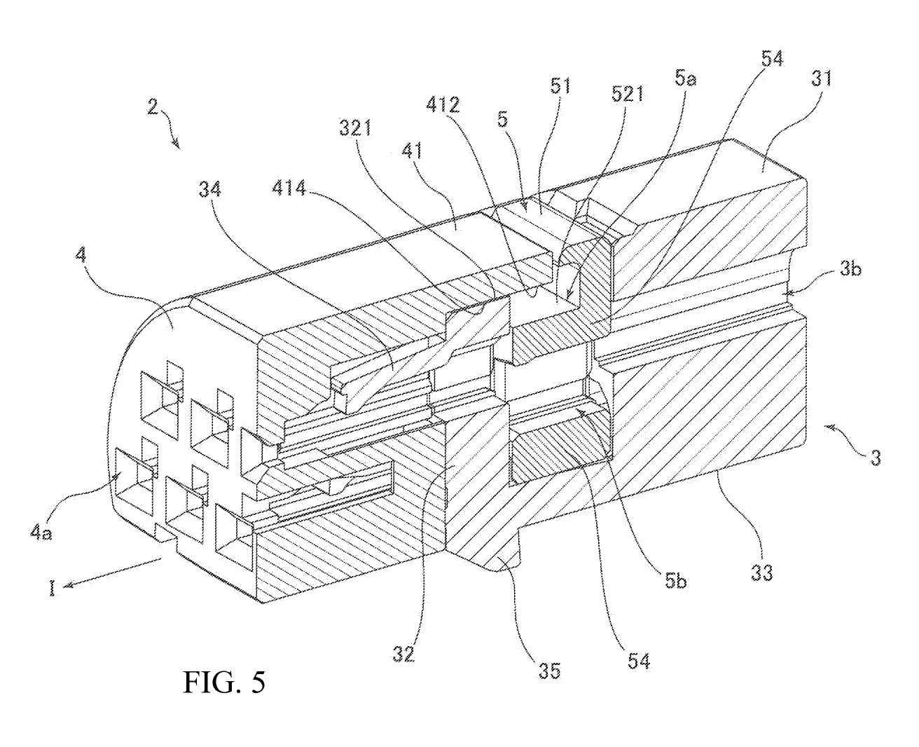

FIG. 1 is a perspective view of the connector 1 in an embodiment of the connector. FIG. 2 is an exploded perspective view of the same connector 1. FIG. 1 and FIG. 2 are reversed in the vertical direction. FIG. 3 is a perspective view of the case 2. FIG. 4 and FIG. 5 are cross-sectional views from line IV-IV in FIG. 3, showing the configuration before and after the retainer 5 has been inserted. Arrow I in the figures indicates the direction in which the connector 1 is inserted into a mating connector (not shown). In the following explanation, insertion direction I is referred to as the forward direction, and the opposite direction is referred to as the reverse direction.

The connector 1 includes a case 2 made of a resin material and a plurality of terminals 8 attached to the leading end portions of corresponding cables 9 are housed inside the case 2. The case 2 has a semi-circular column shape with the axial direction arranged in the longitudinal direction. The case 2 includes a case body 3 in which the plurality of terminals 8 are inserted, a cover 4 mounted on the front side of the case body 3, and a retainer 5 engaging the plurality of terminals 8.

As configured the longitudinal direction of the case body 3 is arranged in the axial direction, the side surface includes a round outer peripheral surface 31 and a flat surface 33. A claw-shaped engaging piece 35 is provided in the flat surface 33 of the case body 3 to engage the mating connector (not shown). The engaging piece 35 protrudes at a right angle from the flat surface 33 of the flat surface 33 at the front end and in the center of the case body 3 relative to the width direction and a includes tapered surface adjacent the front of the case body 3.

Claw-shaped engaging pieces 37 are also provided in the flat surface 33 of the case body 3 to engage the cover 4 with the case body 3. An engaging piece 37 is provided on both sides of the flat surface 33 at the front end in the width direction so as to interpose the other engaging piece 35. A U-shaped engaging piece 47 is provided on the cover 4 to engage the cover 4 with the case body 3. The engaging piece 47 extends in a rear direction at a position corresponding to the engaging pieces 37 of the case body 3.

A plurality of terminal holes 3b are formed in the case body 3 which pass through the case body 3 in the longitudinal direction, and the terminals 8 are inserted into the terminal holes 3b from the rear. A retaining hole 3a is formed in the case body 3 which extends in a direction orthogonal to the longitudinal direction and communicates with the terminal holes 3b. The opening of the retaining hole 3a is formed in a side surface of the case body 3. More specifically, the opening of the retaining hole 3a is formed in the side surface of the case body 3 opposite the flat surface 33 and in the central portion of the circumferential outer peripheral surface 31, and has a rectangular shape.

The case body 3 includes a front wall portion 32 in front of the retaining hole 3a. The front surface of the front wall portion 32 includes a plurality of beam portions 34 extending forward, and an engaging piece 341 provided on the front end portions of the beam portions 34. The engaging pieces 341 engage the hole portions 8b at the front ends of the terminals 8 inserted into the terminal holes 3b. A contact surface 321, which makes contact with the panel portion 41 of the cover 4 described below, is provided in the front wall portion 32 opposite the flat surface 33 in the central portion of the circumferential outer peripheral surface 31.

As shown in FIG. 2 a plurality of terminal holes 4a are formed in the cover 4 which pass through in the longitudinal direction and receive the inserted terminals of the other connector (not shown). The cover 4 has a panel portion 41 which protrudes rearward. A portion of the opening of the retaining hole 3a formed in the case body 3 is notched on the front of the case body to receive the panel portion 41.

The retainer 5 is inserted into the retaining hole 3a formed in the case body 3. In the following explanation, the insertion direction of the retainer 5 (the dotted line arrow in FIG. 2) is down, and the opposite direction is up. A plurality of terminal holes 5b are formed in the retainer 5 which pass through in the longitudinal direction for receiving a portion of the terminals 8 inserted into the case body 3.

An engaging portion 54 is provided vertically in the terminal holes 5b of the retainer 5 for engaging the recessed portions 8a at the rear ends of the terminals 8. The engaging portion 54 of the retainer 5 engages the terminals 8 when fitted into the recessed portions 8a of the terminals 8 inserted into the terminal holes 3b of the case body 3.

A recessed portion 5a with a flat bottom surface 521 opening forward and upward is formed in the front half of the upper end of the retainer 5, and a pressing portion 51 pressed down manually when the retainer 5 is pushed into the retaining hole 3a is formed in the rear half of the upper end of the retainer 5. The recessed portion 5a is described in greater detail below.

When the retainer 5 is inserted into the retaining hole 3a in the case body 3 and the cover 4 is attached to the front end of the case body 3, the connector is in the state shown in FIG. 3 and FIG. 4. When the terminals 8 are then inserted into the case body 3 and the retainer 5 is pushed downward, the connector is in the state shown in FIG. 5 and the terminals 8 are engaged. (In this figure, the terminals 8 are not depicted.) The terminals 8 may be inserted before the cover 4 is attached.

In the present embodiment, as shown in FIG. 3 through FIG. 5, the panel portion 41 provided in the cover 4 is arranged so as to cover a portion of the opening of the retaining hole 3a formed in the cover body 3. More specifically, the panel portion 41 covers the front half of the opening in the retaining hole 3a on the front end. The recessed portion 5a formed in the retainer 5 has a shape which corresponds to that of the panel portion 41 provided in the cover 4. More specifically, the recessed portion 5a has the same shape as the panel portion 41 of the cover 4 as viewed from above so that the panel portion 41 of the cover 4 can be inserted into the recessed portion 5a.

In the panel portion 41 and the recessed portion 5a, the flat opposing surface 412 on the bottom of the panel portion 41 opposes the flat bottom surface 521 of the recessed portion 5a. When the retainer 5 is pulled upward, the opposing surface 412 of the panel portion 41 and the bottom surface 521 of the recessed portion 5a come into contact, and the panel portion 41 exerts a downward counterforce on the retainer 5 which is able to keep the retainer 5 from detaching.

If a downward projecting claw-shaped protrusion were provided in the opposing surface 412 of the panel portion 41 and the retainer 5 were pulled upward, the bottom surface 521 of the recessed portion 5a would come into contact with the protrusion and not the opposing surface 412. This would make it difficult to exert downward counterforce on the retainer 5, and the retainer 5 would become warped. As a result, the retainer 5 would readily become detached.

In the present embodiment, the opposing surface 412 in the rear half of the panel portion 41 facing the bottom surface 521 of the recessed portion 5a and the contact surface 414 in the front half of the panel portion 41 that comes into contact with the contact surface 321 of the front wall portion 32 of the case body 3 are on the same plane. When the cover 4 is attached to the front end of the case body 3, the panel portion 41 of the cover 4 does not catch the upper end of the front wall portion 32 of the case body 3.

If a downward projecting claw-shaped protrusion were provided in the opposing surface 412 of the panel portion 41 and the cover 4 were attached to the front of the case body 3, the protrusion would interfere with the front of the case body 3 and not be allowed to be pushed downward without obstruction and a mechanism would be required to elastically warp the panel portion 41 (such as a notch in a portion of the panel portion 41). However, it would be difficult for the panel portion 41 to exert a downward counterforce on the retainer 5 if the panel portion 41 were easily warped elastically.

In the present embodiment, as shown in FIG. 5, when the retainer 5 has been inserted into the retaining hole 3a and the terminals 8 inserted into the terminal holes 3b have been engaged, the bottom surface 521 of the recessed portion 5a is positioned closer to the opening of the retaining hole 3a than to the terminal holes 3b. Because this maintains the vertical thickness of the engaging portion 54 of the retainer 5 engaging the terminals 8, the rigidity of the engaging portion 54 is improved. As a result, the terminals 8 can be more effectively kept from becoming detached. Alternatively, the bottom surface 521 of the recessed portion 5a can be positioned farther away from the opening of the retaining hole 3a than from the upper ends of the terminal holes 3b.

If a downward projecting claw-shaped protrusion were provided in the opposing surface 412 of the panel portion 41, a space would be required between the bottom end of the protrusion and the bottom surface 521 of the recessed portion 5a to ensure enough room for the retainer 5 to be pushed in. As a result, the bottom surface 521 of the recessed portion 5a would have to be shifted downward from the position shown in FIG. 5. If the bottom surface 521 of the recessed portion 5a were shifted downward, the engaging portion 54 of the retainer 5 would be thinner, and the engaging portion 54 would be less rigid. As a result, the detachment preventing effect on the terminals 8 would be reduced.

In the present embodiment, the panel portion 41 provided in the cover 4 does not have a cutout portion such as a slit. In other words, the panel portion 41 of the cover 4 is continuous along the entire in-plane direction, and has a uniform thickness along the entire in-plane direction. Because the rigidity of the panel portion 41 of the cover 4 is ensured, the counterforce of the panel portion 41 exerted on the retainer 5 can be improved.

An embodiment of the connector was described above, but is not limited to this embodiment in any way. It should be clear to a person skilled in the art that many other modifications are possible within the spirit and scope of the connector.

1. A connector comprising:
a case body including a plurality of terminal holes passing through in one direction for receiving terminals inserted from a rear side, an opening formed in a side surface relative to the one direction, and a retaining hole extending from the opening in a direction orthogonal to the one direction and communicating with the terminal holes;
a retainer inserted into the retaining hole and engaging the terminals inserted into the terminal holes, the retainer having a recessed portion and the recessed portion having a bottom surface;
a cover attached to the other side of the case body in the one direction and including a plurality of terminal holes corresponding to the terminal holes formed in the case body, the cover having a panel portion covering a portion of the opening; and
wherein the recessed portion of the retainer corresponds to the panel portion and the panel portion having an opposing surface opposing the bottom surface of the recessed portion.

2. The connector according to claim 1, wherein the panel portion further comprises a contact surface contacting a side surface of the case body, the opposing surface and the contact surface being on the same plane.

3. The connector according to claim 1, wherein the position of the bottom surface of the recessed portion is closer to the opening than the terminal holes in the insertion direction of the retainer when the retainer has been inserted into the retaining hole and has engaged the terminals inserted into the terminal holes.

4. The connector according to claim 1, wherein the panel portion does not include a cutout portion.

5. The connector according to claim 1, wherein the side surface of the case body opposite the side surface having the opening is formed in a planar shape.
